(19) United States
(12) Patent Application Publication
(10) Pub. No.: US 2014/0085311 A1
(43) Pub. Date: Mar. 27, 2014

(54) METHOD AND SYSTEM FOR PROVIDING ANIMATED FONT FOR CHARACTER AND COMMAND INPUT TO A COMPUTER

(71) Applicant: Co-operwrite Limited, Skelmersdale (GB)

(72) Inventors: Geoffrey Norman Walter GAY, Fairfield, IA (US); Billy MOON, Ennis (IE)

(73) Assignee: Co-operwrite Limited, Skelmersdale (GB)

(21) Appl. No.: 13/974,332

(22) Filed: Aug. 23, 2013

Related U.S. Application Data
(60) Provisional application No. 61/704,896, filed on Sep. 24, 2012.
(60) Provisional application No. 61/704,872, filed on Sep. 24, 2012.

(51) Int. Cl. G06F 3/01

(52) U.S. Cl. CPC G06F 3/017
USPC 345/467

(57) ABSTRACT

A method includes receiving from a user a gesture input and correlating the gesture input with a first animated font character in an animated font character library. As the gesture input continues, the first animated font character morphs into a second animated font character to give a visual appearance to the user of a character forming on the display device. In this regard, the first animated font character and the second animated font character can be component animated font characters that are each segments of a completed animated font character that is formed in step with the gesture input.

This application claims priority to Provisional Patent Application 61/704,896 filed Sep. 24, 2012 and Provisional Patent Application No. 61/704,892 filed Sep. 24, 2012 the entirety of which are incorporated by reference herein. This application is being filed concurrently with Nonprovisional patent application Ser. No. 13/974,272 filed Aug. 23, 2013 titled HANDWRITING RECOGNITION SERVER, by Gay et al. the entirety of which is incorporated by reference herein.

### BACKGROUND

This disclosure is directed to visual feedback, and more specifically to, correlating a private use area of a character encoding method with animated font characters for successive display as visual feedback from an input.

Text input to a small form-factor computer, especially a mobile device such as a smart-phone or personal digital assistant (PDA), equipped with a touch-sensitive screen has historically been via an on-screen keyboard. Because of the small form-factor of mobile devices, the screen is necessarily also small, for example, 50 mm wide by 35 mm high, and the on-screen buttons for the letters of the alphabet are similarly small and require concentration and learned skill to accurately target with the fingers. In addition, the space occupied by the on-screen keyboard is not available for the display of other information, and thus the useful size of the display is further reduced.

To solve this problem, computer algorithms have been developed to allow finger movements over the touch-sensitive screen to input hand-written characters. Such handwriting recognition products take the complex finger movements made during hand-written input and analyze their shape and sequence to interpret the intended characters. These algorithms are complex, have inherent processing delays, are subject to errors of recognition and have not displaced on-screen keyboards in the majority of mobile devices.

### SUMMARY

A method for providing visual feedback on a display device of a gesture input is disclosed. The method includes receiving from a user a gesture input and correlating the gesture input with a first animated font character in an animated font character library. As the gesture input continues, the first animated font character morphs to a second animated font character to give a visual appearance to the user of a character forming on the display device. In this regard, the first animated font character and the second animated font character can be component animated font characters that are each segments of a completed animated font character that is formed in step with the gesture input.

In another embodiment, a system for providing visual feedback on a display device of a gesture input is disclosed. The system includes a gesture input device, display device, a standard font character library with a private use area, and an animated font character library for storing a plurality of animated font characters. The animated font characters include a plurality of component animated font characters and a plurality of completed animated font characters. The component animated font characters can be visual segments of one or more completed animated font characters. In this regard, the completed animated font character can turn into or morph on the display device to a standard font character in the standard font library. In yet another embodiment, the standard font character library described is encoded by the Unicode character encoding method and the private use area is a Private Use Area of the Unicode character encoding method.

### BRIEF DESCRIPTION OF THE FIGURES

FIG. 1 is a schematic block diagram of a system for processing gestures and displaying animated fonts.

FIG. 2A shows an example of gesture recognition with visual feedback.

FIG. 2B is a continuation of the example of gesture recognition with visual feedback shown in FIG. 2A.

FIG. 2C is a continuation of the example of gesture recognition with visual feedback shown in FIG. 2B.

FIG. 2D is a continuation of the example of gesture recognition with visual feedback shown in FIG. 2C.

FIG. 2E is a continuation of the example of gesture recognition with visual feedback shown in FIG. 2D.

FIG. 2F is a continuation of the example of gesture recognition with visual feedback shown in FIG. 2E.

FIG. 3A is a table showing in the column entitled “Animated Image” the visual feedback elements stored in an animated font character library.

FIG. 3B is a continuation of the table of FIG. 3A.

FIG. 3C is a continuation of the table of FIG. 3B.

FIG. 3D is a continuation of the table of FIG. 3C.

FIG. 3E is a continuation of the table of FIG. 3D.

### DESCRIPTION OF THE ILLUSTRATED EMBODIMENTS

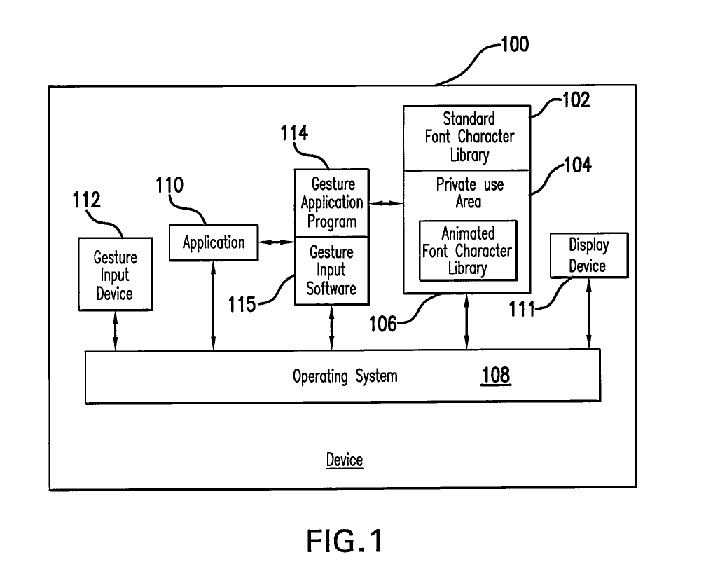

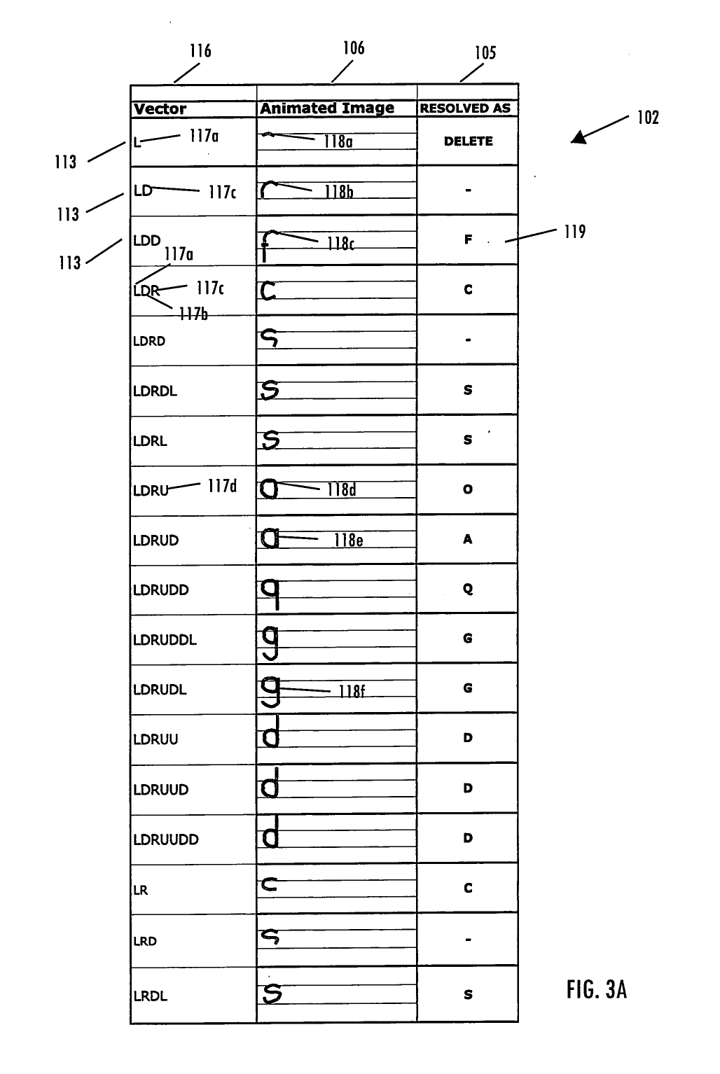

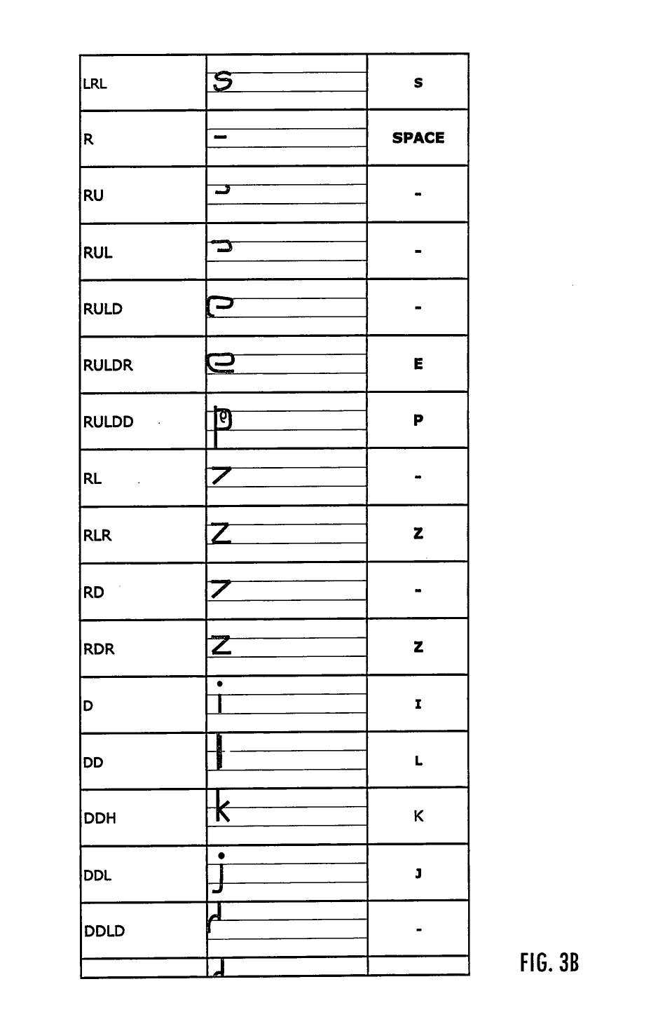

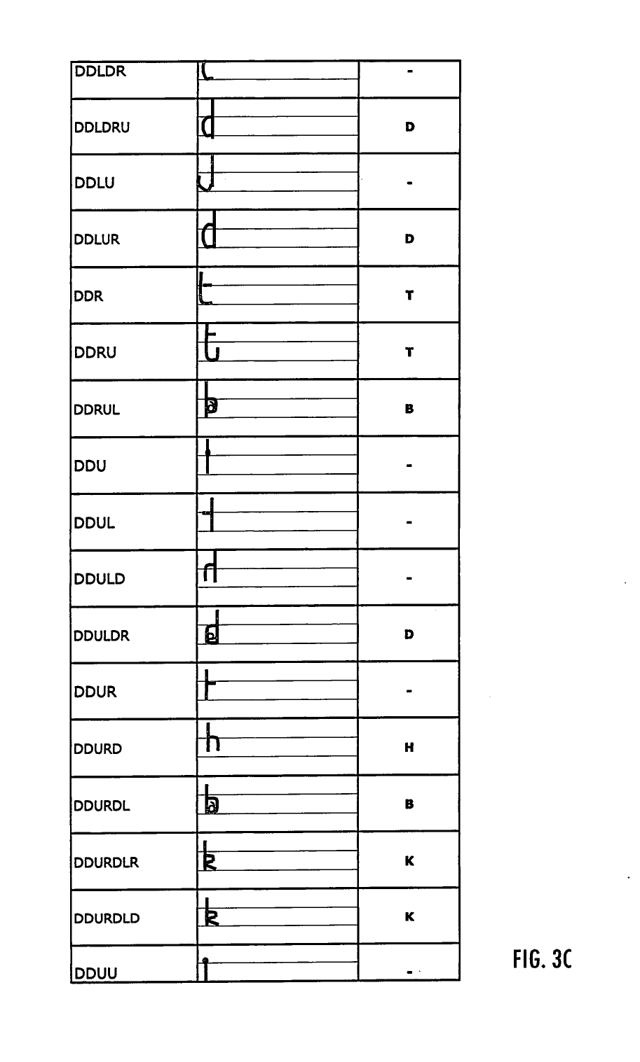

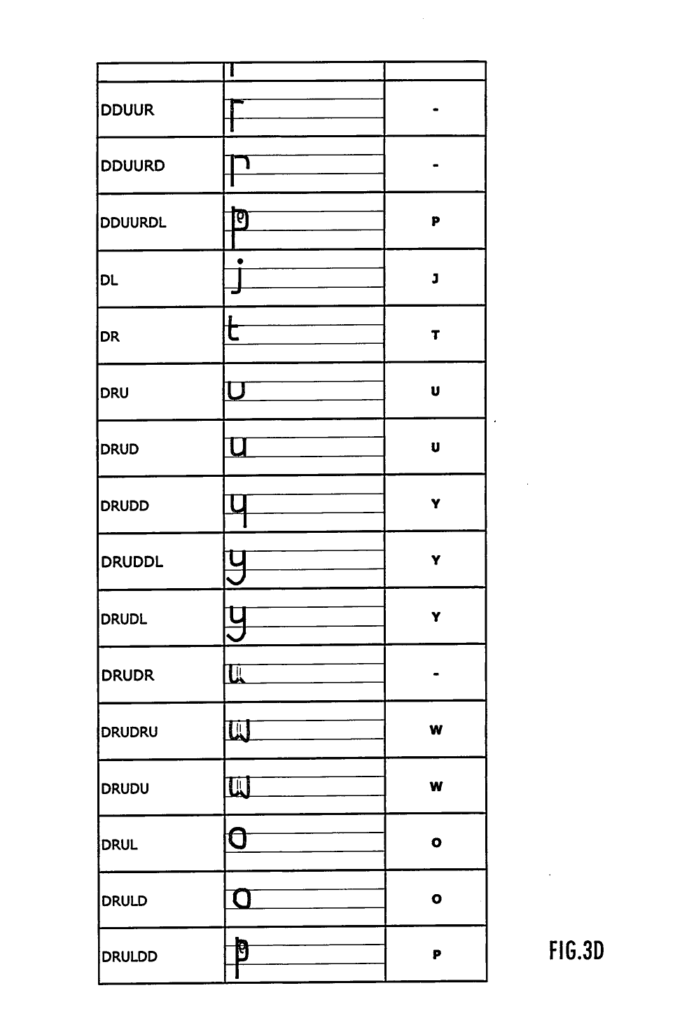

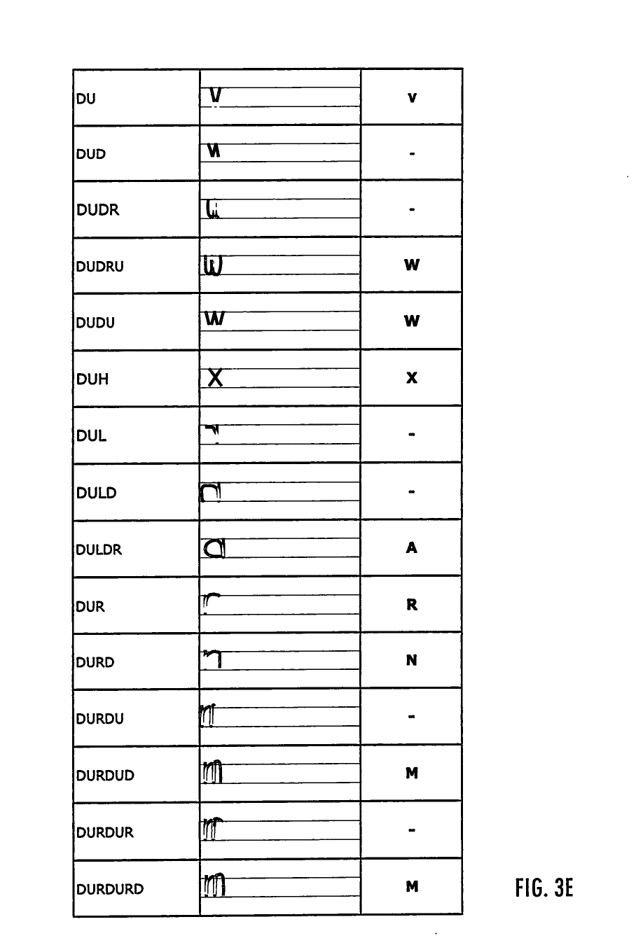

FIG. 1 shows a touch operative input with a visual display device 100 operating in accordance with an embodiment of this disclosure. Device 100 can include a gesture input device 112, which can include a touchscreen input device for receiving a handwritten character input from a gesture in the form of a finger impression on a touchscreen and a display 111. Device 100 includes a standard font character library 102 populated with standard font characters and an animated font character library 106 populated with animated font characters 118, shown in the middle column of a table 107 in FIG. 3.

Standard font characters in standard font character library 102 and animated font characters 118 in animated font character library 106 can be encoded in any character encoding format that includes a private use area. The private use area contains values that are intentionally left undefined, so that third parties may define their own characters without conflicting with the standard character assignments. An example of a character encoding method that includes a private use area is the Unicode character encoding method.

According to the Unicode character encoding method, standard font characters in standard font character library 102 are correlated with values in Unicode Planes 0-14. This correlated standard font character library can be contained in a Unicode font file. This Unicode font file including standard font character library 102 is available to, and widely used by, everyone. Animated font characters 118 in animated character library 106 are correlated with values in Unicode Planes 15-16, which correspond to Unicode's Private Use Area (“PUA”). Only parties with a Unicode font file having animated character library 106 are able to communicate with or use animated font characters 118. One skilled in the art would recognize that animated font character library 106 can be stored in the same file (as shown in FIG. 1) or in a file separate from standard font character library 102, where the font characters in each library 102 and 106 is correlated with the same character encoding method.

Animated font character library 106 includes completed animated font characters (e.g., 118c, d, e, f in FIG. 3), as well as component animated font characters (e.g., 118a, b in FIG. 3). Component animated font characters are parts or segments of a completed animated font characters. A single component animated font character can be a part or segment of one or more completed animated font characters; for example, component animated font character 118a is a segment of completed animated font characters 118c, 118d, 118e, and 118f. Animated font characters 118 are each correlated with a unique numerical value associated with the particular character encoding method, so each animated font character 118 has equal dignity with the standard font characters in font standard font character library 102. This allows device 100 to receive, process, and display each animated font character 118 in the same manner, and with the same speed and efficiency, as any standard font character in standard font character library 102.

Device 100 includes at least one application 110 running on an operating system 108. Application 110 can be a typical word processing application 110 or any other type of application that a user may use to compose, edit or format written material. Device 100 includes at least one gesture analysis program 114 (which can reside in a gesture analysis module) running on operating system 108. Gesture analysis program 114 receives a handwriting input from gesture input device 112 and accesses standard font character library 102 directly, or through operating system 118, and passes animated font characters 118 to display device 111 for display of visual feedback.

Gesture input software 115 operating in gesture analysis program 114 translates gestures received from a user from gesture input device 112, into a unique code that can be associated with animated font characters 118 in animated font character library 106. In an embodiment with a touchscreen for gesture input device 112, the gesture can begin with a finger impression on the touchscreen and continue in the form of a continuous impression until the impression is removed from the touchscreen. In an embodiment, gesture input software 115 in gesture analysis application 114 translates gestures into directional components or unit vectors. An example of such software can be found in U.S. Pat. No. 6,647,145, the contents of which are hereby incorporated by reference herein. These unit vectors can be associated with the numerical values associated with the particular character encoding method and correspond with animated font characters 118 in animated font character library 106 of standard font character library 102. One skilled in the art would understand, however, that any gesture input software 115 can be used, provided that it can translate a gesture input from gesture input, device 112.

FIG. 3 is table 107 that correlates animated font characters 118 in animated font character library 106, as shown in the middle column entitled “Animated Images,” with unit vectors 117 and standard characters in column 105. The first column in table 107 shows the contents of a register 116, which stores unit vectors 117 as they are derived from the gesture input. Each unit vector 117 can be associated with the direction of the gesture with respect to an initial reference point or axis or indeed any recognized characteristic of the inputted gesture. Unit vectors 117 include an “L” unit vector 117a that corresponds with a left gesture, an “R” unit vector 117b that corresponds with a right gesture, a “D” unit vector 117c that corresponds with a down gesture, and a “U” unit vector 117d that corresponds with an up gesture. In this regard, each direction of a gesture with respect to the initial reference point can be stored in register 116 until the gesture is terminated. One or more unit vectors 117 are summed together to create unique unit vector words 113 in column 116 of table 107. It should be understood that any characteristic of the inputted gesture can be recognized by gesture analysis program 114 and used to generate a code for the selection of an appropriate animated font character 118 for visual display on display device 111. Also a standard font character can be drawn using a series of discrete strokes, for example, the English letter “x” or Japanese or Chinese character.

Each vector word 113 in column 116 is associated with a unique animated font character 118 in animated font character library 106. Animated fonts 118 include completed animated font characters (e.g., 118c, d, e, f in FIG. 3), as well as component animated font characters (e.g., 118a, b in FIG. 3). Once a gesture input is initiated, register 116 is populated with one or more unit vectors 117 as the gesture progresses to create one of vector words 113 in register 116. Each vector word 113 is associated with a numerical value corresponding to one of animated font characters 118, which will be displayed on display device 111 in step with the formation of vector word 113. Component animated font characters morph into further component animated font characters or completed animated font characters giving the visual appearance to the user of an animated letter growing and forming according to the gesture movements. When the user concludes the gesture, the complete animated font character turns into its corresponding standard font character.

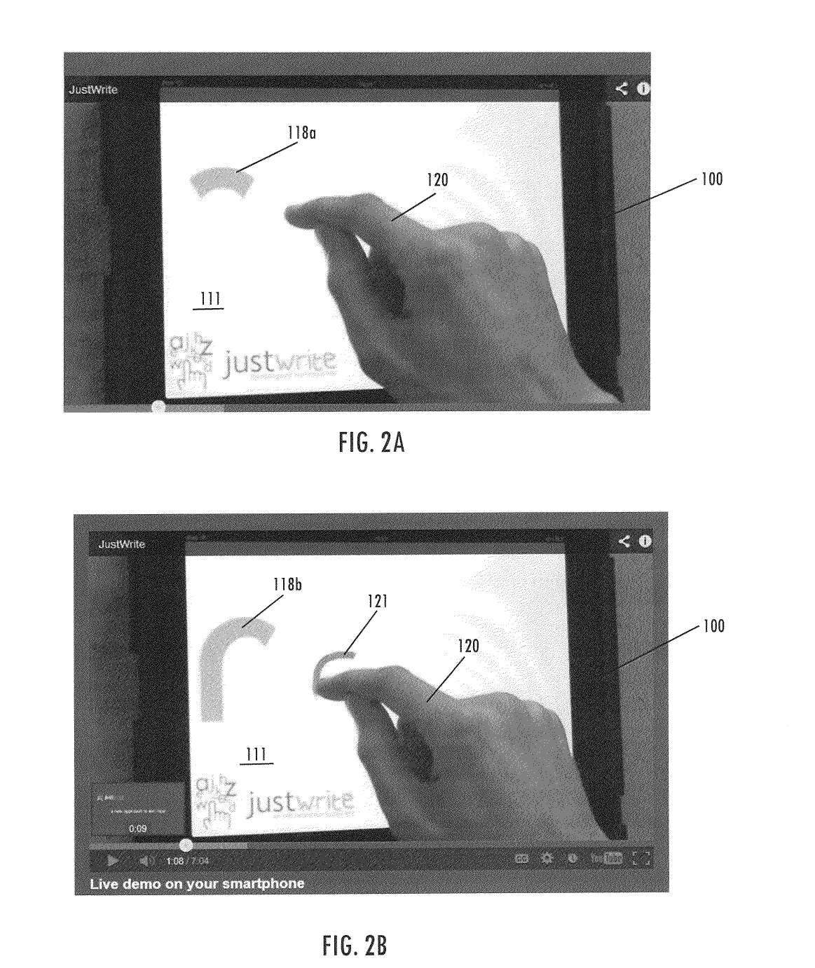

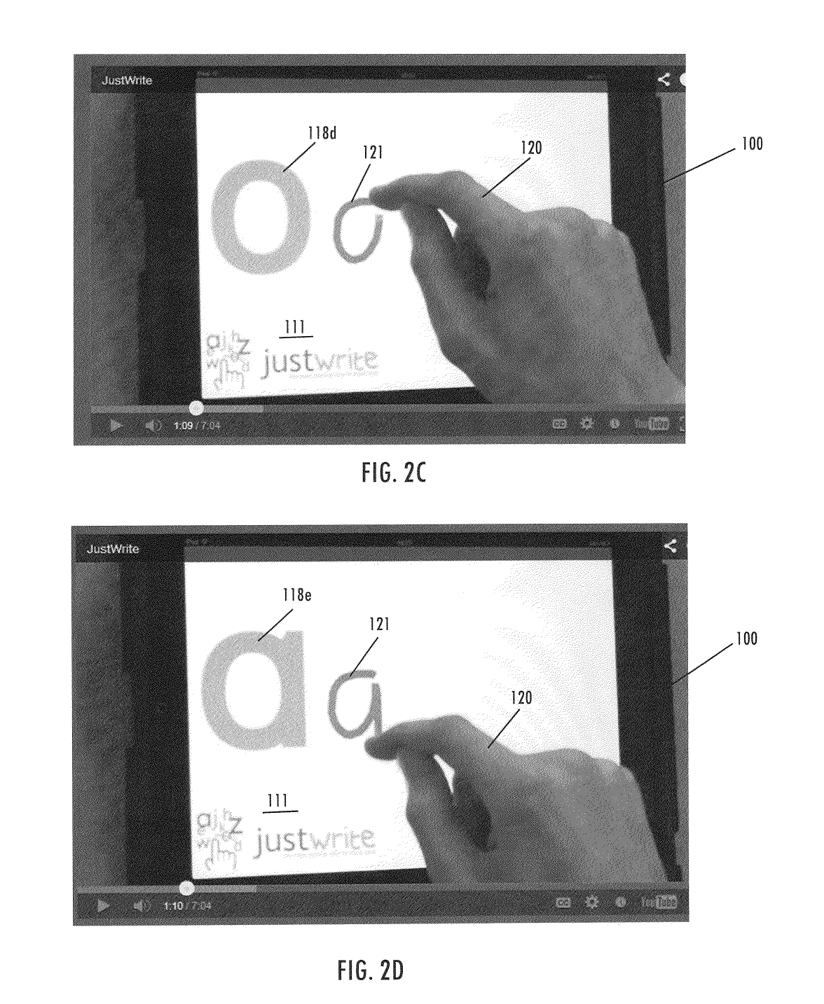

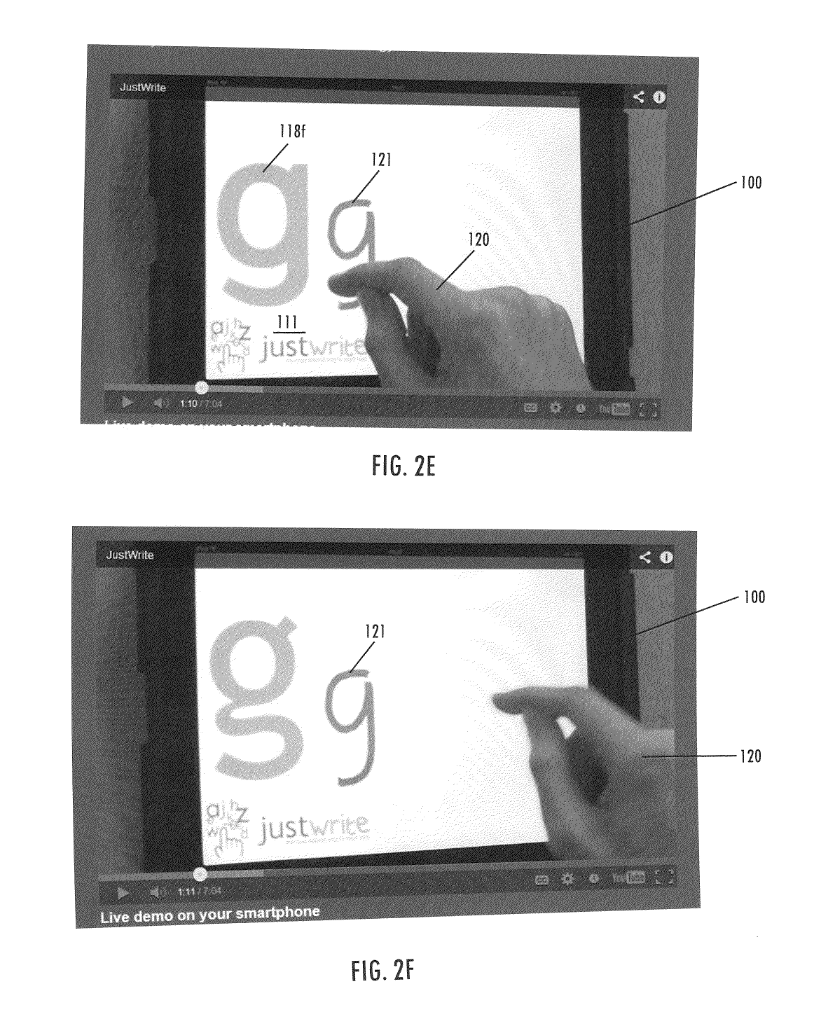

FIGS. 2A-2F demonstrates a user's finger 120 forming the standard character, the letter “g” on device 100 with the animated visual feedback of animated font characters 118 forming on display device 111. A glyph 121 tracks the gesture of user 120 and simultaneously displays animated font characters 118 on display device 111. Glyph 121 is for illustrative purposes of this disclosure to aid in the description of a gesture input into device 100. What is important is the near instantaneous visual feedback that user 120 sees from animated font characters 118 forming on display device 111.

User 120 begins, as shown in FIG. 2 A, with a gesture in the left direction from an initial reference. The gesture is translated by gesture analysis program 114 into L unit vector 117a and stored in register 116. Gesture analysis program 114 passes the numerical value associated with L unit vector 117a to operating system 108. Operating system 108 uses its native font rendering algorithms to display animated font character 118a from animated font character library 106 of standard font character library 102. If user 120 stops the gesture at this point by removing his finger, the gesture input would be interpreted as a “delete” input with visual feedback in the form of animated image 118a (shown in row 1 of the table of FIG. 3).

User 120 continues to form the letter “g” on device 100 by continuing the gesture in the down direction, as shown in FIG. 2B. Register 116 is provided with D unit vector 117c, as described above, and animated font character 118b is shown on display device 111. User 120 continues the gesture in the right direction followed by the up direction, as shown in FIG. 2C. Register 116 is provided with R unit vector 117b and U unit vector 117d, and animated font character 118d is shown on display device 111. The transition of animated image 118a through the subsequent curve toward the right direction can be a compromise between successive animated font characters, in this example animated font characters 118c and the animated font character corresponding with the letter “c” and vector word LDR, so the user is presented with a smooth transition or morph. If user 120 stops the gesture with the register containing LDRU by removing his finger, the gesture input would turn into the letter “o.”

User 120 continues the gesture in the down direction in the continuing process of forming the letter “g”, as shown in FIG. 2D. Register 116 is provided with another D unit vector 117c. Register 116 now contains LDRUD; so animated font character 118e is shown on display device 111. If user 120 stops the gesture at this point, the gesture input would turn into the letter “a.”

User 120 continues the gesture in the left direction to form the letter “g”, as shown in FIG. 2E. Register 116 is provided with L unit vector 117a, which now contains LDRUDL, so animated font character 118f, which corresponds to the lower-case form of the basic Latin alphabet letter “g”, is shown on display device 111. FIG. 2F shows user 120 indicating the gesture is completed by removing his finger or un-touching gesture input device 112 of device 100. Animated font character 118f immediately turns into standard font character for the letter “g” in standard font character library 102.

Animated font characters 118a-f appear successively on display device 111, as though they are morphing into a fully-formed letter “g.” These completed animated font characters turn into standard font characters in the standard font character library 102, which can be combined together to form a sequence (word, sentence, paragraph, document) of standard font characters. In this manner, display device 111 shows the drawn parts of a letter in real time, in response to gesture movements of user 120, giving the visual appearance to the user of an animated letter appearing on display 120 that seems to grow and form according to the gesture movements. This allows user 120 to observe a precise and neat character throughout the entire gesture input on device 100. Each animated font character 118 is treated as a standard font character of standard font character library 102, and is associated with a numerical value, so each animated font character 118 is recognized by operating system 108 of device 100 at the machine code level allowing for nearly instantaneous recognition of the gesture input by device 100.

Animated font characters 118 can be displayed as outline or vector fonts or as conventional bitmap fonts. A vector font uses drawing instructions and mathematical formulas to describe each glyph or character, while bitmap fonts consist of a matrix of dots or pixels representing the image of each glyph or character. Display of these animated font characters 118 as a conventional bitmap within the time intervals required by user 120 for visual feedback of rapid text entry and with changing scales of the displayed animated font characters 118, however, can pose specific problems of coding and execution of the computer code. Resealing pixel-based font is complex. Maintaining the pixel based font at different scales requires extra storage space and processing power, and increases inefficiency proportionally to the number of scales supported. Making any change to a pixel based font requires re-drawing as many animated font characters 118 as are supported. While some sizes scale gracefully, others require manual modifications. Editing a vector font is simpler, as the developer only needs to make the changes once.

Vector font can be rendered dynamically. JavaScript can be used to modify scalable vector graphic files, so that it becomes trivial to modify the shape of animated font character 118 according to a simple set of rules. This allows the developer to define an algorithm to determine the progress a user's finger makes along a path on gesture input device 112, and then, re-calculate in an analog manner, and re-render the displayed animated font character 118.

Vector font allows for animated font characters 118 to be scaled using native operating system algorithms, which offload the complex work of handling text rendering and obtain the benefits from advanced features of font rendering as provided by operating system 108. Native operating system algorithms come embedded in operating system 108, and are in common use, which allows the deployment of more advanced font files that use vector-based graphics, such as OpenType™ or TrueType™ fonts. These fonts allow mathematical determination of rendering font characters at different sizes and circumstances. Thus, the required manipulations of displayed fonts are already coded into the operating system 108 as optimized, efficient code, and the task of coding software to manipulate animated font characters 118 is greatly simplified. Examples of advanced features handled by operating system 108 are sub-pixel rendering, anti-aliasing, and kerning, as well as any other performance enhancements. This results in the smoothest possible font animation, with a frame rate that accurately follows finger etc. movements.

Furthermore, when inserting graphics into text, operating system 108 expects to handle the graphics as a word boundary. This leads to unexpected behavior, including splitting words at the wrong places. There is no easy way to solve this issue by overriding operating system 108. Populating private use area 104 with animated font characters 118, however, allows animated font characters 118 to be inserted into a standard text control of many operating systems, automatically handling the animation as part of the word it is building. This also allows the animation to occur in real time in the text area of the document.

Using graphic based animation requires potentially complex calculations to align with text (depending on the implementation). Such complex calculations can be avoided by putting the animation frames (e.g., animated font characters 118) into a font file (e.g., animated font character library 106). The font file can then be implemented with any font algorithm on any platform. These standard font algorithms simply insert the characters into a string. This avoids the need to calculate the position and scale of the animation according to current text content.

The user desires smooth visual feedback of animated font characters 118 on display device 111. Sudden changes of apparent position of component animated font characters (e.g., 118a, b) with respect to previously displayed component animated font characters (e.g., 118a, b) can disorient the user and give a jerky or discontinuous visual feedback and render character input less easy and efficient. Furthermore, correlating animated font characters 118 with values outside the private use area 104 of a standard font character library 102 would cause “collisions” between animated font characters 118 and standard font characters. These collisions would interrupt the successive visual display of animated font characters 118.

The system and methods described herein can be used globally, as a standard (or animated) font in any language, without interfering with existing writing methods. Standard characters from any language can be deconstructed into partial, component characteristics or characters to form a unique animated font character library 106 full of partial, component and complete characters.

Furthermore, this disclosure is not limited to fonts. An animation character library is disclosed where any animation can be deconstructed into frames to populate the animation library with each frame being treated as an animated font characters 118 and populated in animated font character library 106 for loading into private use area 104. This may prove particularly useful in the video game industry or in any interactive animation displays controlled by user gesture input. Instead of using considerable processing power to animate a scene, an animated visual scene can be quickly displayed by invoking a script containing a series of inputs corresponding to a sequence of frames stored in animated font character library 106 allowing the animation to be carried out natively by operating system 108.

Device 100 can be any form of digital computer, including a desktop, laptop, workstation, mobile device, smartphone, tablet, and other similar computing devices. Generally, device 100 includes a processor, memory, an input/output device such as a display device 111, a communication interface, and a transceiver, among other components. The device 100 may also be provided with a storage device, such as a microdrive or other device, to provide additional storage. Each of these components is interconnected using various buses, and several of the components may be mounted on a common motherboard or in other manners as appropriate.

The processor can execute instructions within the computing device 100, including instructions stored in the memory. The processor may be implemented as a chipset of chips that include separate and multiple analog and digital processors. The processor may provide, for example, for coordination of the other components of the device 100, such as control of user interfaces (e.g. gesture input device 112), applications 110 run by device 100, and wireless communication by device 100.

The processor may communicate with a user through a control interface, and a display interface coupled to display 112. The display interface may comprise appropriate circuitry for driving display 112 to present graphical and other information to a user. The control interface may receive commands from a user and convert them for submission to the processor.

The processor can utilize any operating system 108 configured to receive instructions via a graphical user interface, examples of such operating systems include MICROSOFT WINDOWS, UNIX, and so forth. It is understood that other, light weight operating systems can be used for basic embedded control applications. In this regard, the processor executes one or more computer programs, such as applications 110, gesture application program 114 with gesture input software 115, and any other software to carry out the methods and implement the systems described herein, that provide functionality in addition to that of the operating system 108. Generally, operating system 108, standard font character library 102, including animated character library 106, and the computer programs are tangibly embodied in a computer-readable medium, e.g. one or more of the fixed and or removable data-storage devices. Both the operating system 108 and the computer programs may be loaded from such data-storage devices into memory for execution by the processor. The computer programs comprise instructions which, when read and executed by the processor, cause the same to perform the steps necessary to execute the steps or features of the present invention.

The touchscreen input device for a gesture input device can include display panel 111 and input panel 112, where input panel 112 is transparent and overlaid on display panel 111. The touch-sensitive area is substantially the same size as the active pixels on display panel 111. Display panel 111, however, could be any type of display or panel, even including a holographic display, while gesture input device 112 could be a virtual-reality type input where the gesture input is performed in the air or some other medium.

While this disclosure has been particularly shown and described with reference to exemplary embodiments, it should be understood by those of ordinary skill in the art that various changes, substitutions and alterations can be made herein without departing from the scope of the invention as defined by the appended claims and their equivalents.

What is claimed is:

1. A method for providing visual feedback of a gesture input, comprising:
receiving the gesture input;
correlating the gesture input with a first animated font character in an animated font character library, wherein the animated font character library is associated with a private use area of a character encoding method; and
displaying the first animated font character from the animated font character library on a display device.

2. The method of claim 1, and further comprising resolving the first animated font character into a second animated font character to give a visual appearance to a user of a character forming on the display device.

3. The method of claim 2, wherein the first animated font character and the second animated font character are component animated font characters that are each a segment of a completed animated font character.

4. The method of claim 3, wherein the character encoding method is a Unicode character encoding method and the private use area is a Private Use Area of the Unicode character encoding method.

5. The method of claim 1, wherein the animated font character library further comprises a plurality of animated font characters.

6. The method of claim 5, wherein the plurality of animated font characters are each directly associated with a numerical value for execution by a machine code.

7. The method of claim 5, wherein the plurality of animated font characters include a plurality of component animated font characters and a plurality of completed animated font characters, wherein at least two of the component animated font characters are segments of at least one of the completed animated font characters, and wherein the completed animated font character turn into to a standard font character library.

8. The method of claim 1, wherein the first animated font is a vector font.

9. A system for visual feedback of a handwritten character input, the system comprising:
a standard font character library having a plurality of standard font characters;
an animated font character library correlated with a private use area, wherein the animated font character library further having a plurality of animated font characters, wherein the animated font characters further having a plurality of component animated font characters and a plurality of completed animated font characters, wherein at least two of the component animated font characters are segments of at least one of the completed animated font characters; and
a display device for displaying animated font characters from the animated font character library.

10. The system of claim 9, wherein the completed animated font character turns into on the display device to one of the plurality of standard font characters in the standard font character library.

11. The system of claim 9, further comprises a gesture input device to receive the handwritten character input.

12. The system of claim 11, further comprise a gesture analysis program with a register that stores a value that changes as the gesture analysis program translates the handwritten character input, wherein the display device successively displays the animated font character that corresponds with the value each time the value changes.

13. The system of claim 12, wherein the display device successively displays at least two component animated font characters followed by a completed animated font character.

14. The system of claim 9, further comprise a gesture input device to receive the handwritten character input, and a gesture analysis program, wherein the handwritten character input begins with an impression on the gesture input device and includes a continuous impression on the gesture input device while simultaneously the gesture analysis program translates the continuous impression for the display device to display at least two of the plurality of component animated font characters followed by at least one of the plurality of completed animated font characters before the impression is removed from the gesture input device.

15. The system of claim 14, wherein the at least one of the plurality of completed animated font characters turns into a standard font character in the standard font character library.

16. The system of claim 9, wherein the standard font character library is encoded according to a Unicode character encoding method and the private use area is a Private Use Area of the Unicode character encoding method.

17. A computer device comprising:
a standard font character library having a plurality of standard font characters;
a private use area having an animation library;
a plurality of frames in the animation library that when arranged in a sequence show an animated visual scene; and
a display device for displaying the plurality of frames.

18. The device of claim 17, wherein the plurality of frames is a plurality of animated font characters, wherein the animation library is an animated font character library, wherein the animated font characters further having a plurality of component animated font characters and a plurality of completed animated font characters, wherein at least two of the component animated font characters are segments of at least one of the completed animated font characters.

19. The device of claim 17, further comprises a gesture input device to receive a handwritten character input, and a gesture analysis program with a register that stores a value that changes as the font engine translates the handwritten character input, wherein the display device successively displays the animated font character that corresponds with the value each time the value changes, wherein the display device successively displays at least two component animated font characters followed by a completed animated font character.

20. The device of claim 17, wherein the standard font character library is encoded according to a Unicode character encoding method and the private use area is a Private Use Area of the Unicode character encoding method.
